(19) United States
(12) Patent Application Publication
(10) Pub. No.: US 2015/0074423 A1
(43) Pub. Date: Mar. 12, 2015

(54) Digitizing Documents

(71) Applicants: Florian Kreitmaier, Hohenbrunn (DE); Andreas Köpf, Munchen (DE)

(72) Inventors: Florian Kreitmaier, Hohenbrunn (DE); Andreas Köpf, Munchen (DE)

(21) Appl. No.: 14/390,925

(22) PCT Filed: Mar. 18, 2013
(86) PCT No.: PCT/EP2013/055505

§ 371 Date: Oct. 6, 2014

(30) Foreign Application Priority Data
Apr. 16, 2012 (DE) 10 2012 206 202.5

(51) Int. Cl. G06F 21/62; G06F 7/58; G06F 21/60

(52) U.S. Cl. CPC G06F 21/6209; G06F 21/602; G06F 7/582
USPC 713/189; 726/27; 380/46

(57) ABSTRACT

The present embodiments disclose methods and devices for digitizing documents. The device includes a document-scanning device designed to digitize at least one document existing as a hard copy, and having a security device that is designed to protect the at least one digitize document against unauthorized access on the basis of an identifier that is only valid once.

### CROSS-REFERENCE TO RELATED APPLICATIONS

The present patent document is a §371 nationalization of PCT Application Serial Number PCT/EP2013/055505, filed Mar. 18, 2013, designating the United States, which is hereby incorporated by reference, and this patent document also claims the benefit of DE 10 2012 206 202.5, filed on Apr. 16, 2012, which is also hereby incorporated by reference.

### TECHNICAL FIELD

The present embodiments relate to an apparatus for digitizing documents and to a corresponding method.

### BACKGROUND

Although the present embodiments are described below particularly in relation to multifunction printers, the embodiments are not limited thereto, but rather may be used with any type of digitization apparatus.

In an industrial environment. documents may not just be exchanged by mail. Instead, electronic facilities are used in order to digitize documents that are present in paper form and to exchange these documents in electronic form.

Appliances of this kind may be simple scanners, for example. For commercial applications, but also for private use, what are known as multifunction appliances, also called MFD (multi functional device), are also known. These MFDs may be a combination of printer, copier, scanner and fax, for example.

Furthermore, such appliances may have a network connection that is be used to couple these appliances to a data network.

In order to provide digitized documents, these MFDs may also have a web server that allows digitized documents to be downloaded. In addition, these MFDs may also have an interface to an e-mail server that allows digitized documents to be transmitted to a user by e-mail.

In this context, the access to the digitized documents stored on the web server of an MFD and the transmission of the digitized documents to a user by e-mail may take place in unprotected form.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the present embodiments to provide a way of protecting digitized documents. Although the present embodiments are described below particularly in relation to multifunction printers, the embodiments are not limited thereto, but rather may be used with any type of digitization apparatus.

Accordingly, an apparatus is provided for digitizing documents having a document scanning device. The apparatus is designed to digitize at least one document that is present in paper form, and include a security device that is designed to protect the at least one digitized document against unauthorized access on the basis of a valid-once identifier.

A method is also provided for digitizing documents having acts of digitization of at least one document that is present in paper form, and protection of the at least one digitized document against unauthorized access on the basis of a valid-once identifier.

The insight on which the present embodiments are based is that, particularly in commercial environments, a way of being able to handle documents confidentially may be advantageous.

The embodiments are based take account of this insight and provide a way of protecting documents on the basis of a valid-once identifier.

According to the present embodiments, documents are digitized by the document scanning device and the documents are then protected against unauthorized access by the security device. In this case, provision is made for a new identifier to be used for each digitization process.

The use of valid-once identifiers makes it possible to provide that, in a large company, for example, documents may be edited securely. If a standard identifier were used in a company, for example, it would be very easy for potential attacker to access all the documents of a company if this standard identifier were compromised.

If it were possible for users of the apparatus to select the identifier without restriction, there would also be the danger of a user always selecting the same identifier. This makes it much easier for a potential attacker to access the documents of this user. The attacker may only need to gain possession of a single identifier in order to access all the documents of this user.

In one embodiment, the security device has a key derivation device that is designed to calculate a cryptographically secure key from the valid-once identifier for the purpose of protecting the at least one digitized document. This increases the security of the digitized document that is to be protected and allows a convenient approach for a user. Thus, the use of a key derivation device allows an easily remembered identifier, e.g., a 4-digit number, to be used as an identifier that a user may easily remember. Nevertheless, the digitized document may be protected effectively.

If this identifier were to be used directly as a key for protecting a digitized document, for example, it would be easy for an attacker to gain access to this document.

On the other hand, if a cryptographically secure key is derived from the identifier, it may become difficult for an attacker, or impossible with computation powers today, to access the protected digitized document.

The key derivation device may derive a cryptographically secure key by a key derivation function (“KDF”) (KDF1, KDF2, KDF3, KDF4), a mask generation function (“MGF”) (MGF1), a password-based key derivation function (“PBKDF”) (PBKDF-Schneider, PBKDF1, PBKDF2), and/or a scrypt based algorithm, for example.

In one embodiment, the key derivation device is designed to additionally use what is known as a “salt” for calculating a cryptographically secure key on the basis of the valid-once identifier. In cryptography, a “salt” refers to a series of characters (e.g., a random series of characters) by which an identifier is extended when the identifier is used to calculate a key.

In one embodiment, a data memory is provided. In addition, the security device is designed to store the at least one digitized document in the data memory and to protect the at least one digitized document by password-protected access to the data memory that is based on the valid-once identifier and/or the calculated cryptographically secure key.

If the digitized document is protected by password-protected access to a data memory, the protected digitized document may be retrieved from different electronic appliances by the user.

In one embodiment, the security device is designed to encrypt the at least one digitized document on the basis of the valid-once identifier and/or the calculated cryptographically secure key.

If the digitized document is encrypted cryptographically, it is possible to provide that the encrypted digitized document may not be opened by an attacker even if he does not receive the document until the user who has digitized the relevant document has already retrieved it. This may be accomplished by hacking into the computer of the user, for example.

In one embodiment, the security device has a random number generator that is designed to stipulate the valid-once identifier at random. This makes it possible to provide that an attacker may not derive an identifier from previous identifiers or by observing the apparatus.

In one embodiment, the random number generator is designed to stipulate the valid-once identifier at random on the basis of a secrecy level that is prescribed for the at least one digitized document. If different secrecy levels are stipulated for the digitized documents and the identifier stipulated on the basis of these stipulated secrecy levels, it is possible for the identifier, (e.g., the complexity of the identifier), to be matched to the individual secrecy levels.

In one embodiment, the security device is designed to request the valid-once identifier from a user. This allows a user himself to stipulate a valid-once identifier.

In one embodiment, the valid-once identifier may be stipulated by the random number generator at random and displayed to a user. The latter may then decide whether he stipulates an identifier himself or wishes to keep the randomly generated identifier for protecting the digitized document.

In one embodiment, a network interface is provided. In addition, a control device is provided that is designed to transmit the at least one protected digitized document to a prescribed receiver via the network interface as an attachment to an electronic message.

This allows automatic transmission of a protected digitized document to a user. This reduces the effort that is required from a user in order to gain possession of the protected digitized document. Since the user does not have to concern himself with retrieving a protected digitized document, this also increases the acceptance of the apparatus.

In one embodiment, the control device is designed to encrypt the electronic message and the attachments contained therein prior to sending on the basis of a symmetric and/or an asymmetric encryption method. This allows a further increase in the security of the protected digitized document. In addition, it allows not only protection of the document but also total concealment of what content the electronic message has from an outsider.

In addition, it is possible to take a secrecy level that is stipulated for a digitized document, for example, as a basis for deciding what type of encryption is used to protect the relevant digitized document.

In one embodiment, the control device is designed to access a directory service in order to request a key for a receiver of the electronic message. In this case, the directory service may be a Lightweight Directory Access Protocol (LDAP) directory or any other directory that has information about possible receivers of the electronic message, for example. Such directory services may also be referred to as key servers. This allows a cryptographically protected message to be transmitted to a multiplicity of users, even if the sender of the electronic message does not know the keys of the individual receivers.

In one embodiment, a user of the apparatus may print the valid-once identifier on a printing device of the apparatus. If a user is provided with the option of printing the valid-once identifier, he does not need to remember it. Since the identifier is valid just a single time, this does not constitute a great security risk.

The above refinements and developments may, where appropriate, be combined with one another as desired. Further possible refinements, developments and implementations include not explicitly cited combinations of features that are described above or below in respect of the exemplary embodiments. In particular, a person skilled in the art will also add individual aspects in this case as improvements or additions to the respective basic form.

Within the context of this application, the term valid-once identifier denotes a numerical code and/or an alphanumeric code that, from a cryptographical point of view, affords little security when this code is used directly as a key for encryption.

Within the context of one possible embodiment, an identifier that may be used just a single time in a prescribable period may be understood as being valid once. There is thus no absolute exclusion of each identifier that has already been used. In the case of four-digit numerical identifiers, for example, it is possible to stipulate that an identifier that has already been used may be reused if, by way of example, 80% of the possible number combinations from the set of four-digit numbers have already been used. For identifiers of other numerical magnitudes or for alphanumeric identifiers, it is similarly possible to prescribe particular limits or periods. Alternatively, the period may be defined in hours, days, weeks, months, and/or years.

### BRIEF DESCRIPTION OF THE DRAWINGS

FIG. 1 depicts a block diagram of an exemplary embodiment of an apparatus for digitizing documents.

FIG. 2 depicts a flowchart for an exemplary embodiment of a method for digitizing documents.

FIG. 3 depicts a block diagram of a further embodiment of an apparatus for digitizing documents.

In all the figures, elements and apparatuses that are the same or have the same function have been—unless stated otherwise—provided with the same reference symbols.

### DETAILED DESCRIPTION

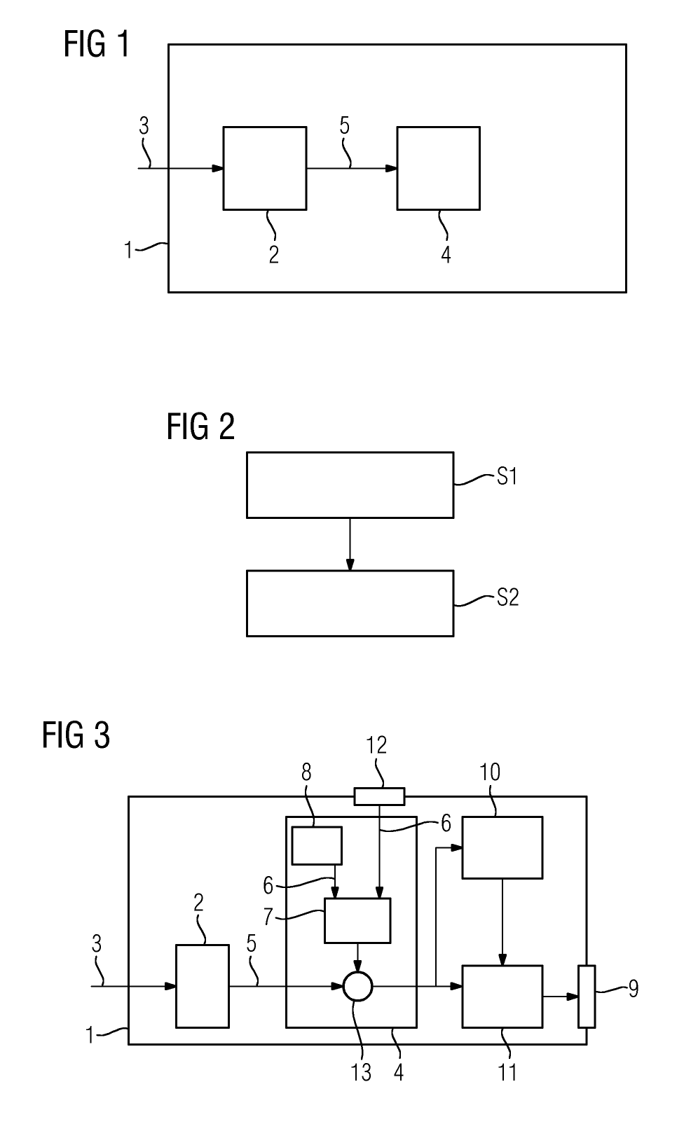

FIG. 1 depicts a block diagram of an exemplary embodiment of an apparatus 1. The apparatus 1 in FIG. 1 is in the form of a multifunction appliance, also MFD (multi functional device). In further embodiments, the apparatus 1 may also be in the form of a simple scanner 1, for example.

The MFD in FIG. 1 has a scanner 2 that is designed to digitize or scan a document 3 that is present in paper form. The scanner 2 is connected to a security device 4 to which the scanner 2 transmits the digitized document 5. The security device 4 is designed to protect the digitized document 5 against unauthorized access by a valid-once identifier 6.

In this case, the valid-once identifier 6 is in the form of a numerical PIN or alphanumeric password that is easy for a user of the MFD 1 to remember. By way of example, the valid-once identifier 6 may be a four-digit or six-digit number.

By way of example, the security device 4 may be a security module that has a digital circuit that is suitable for cryptographic calculations. By way of example, this digital circuit that is suitable for cryptographic calculations may be a “trusted platform module” (TPM). Alternatively, the security device 4 may also be in the form of a program module that is executed by a processor of the MFD 1.

The security device 4 may secure the digitized document 5 in different ways on the basis of the valid-once identifier 6. By way of example, the security device 4 may encrypt the digitized document 5 on the basis of the valid-once identifier 6. In this case, the security device 4 may use the valid-once identifier 6 directly as a key for encrypting the digitized document 5. This has the advantage that the encryption may be performed quickly, since the calculations may be performed easily on the basis of the valid-once identifier 6, which is short from a cryptographic point of view. In a further embodiment, the security device 4 may use the valid-once identifier 6 indirectly as a key for encrypting the digitized document 5. In such an embodiment, the security device 4 may derive a cryptographically secure key from the valid-once identifier 6 for the purpose of encrypting the digitized document 5.

In a further embodiment, the security device 4 may protect the digitized document 5 against unauthorized access by virtue of the digitized document 5 being stored at a password-protected memory location, with the password for accessing the memory location corresponding to the valid-once identifier 6 or being derived therefrom.

FIG. 2 depicts a flowchart for an exemplary embodiment of a method.

The method for digitizing documents begins with the act of digitization 51 of at least one document 3 that is present in paper form. In act S2, the at least one digitized document 5 is protected against unauthorized access on the basis of a valid-once identifier 6.

In one embodiment, the method has the further act of calculation of a cryptographically secure key from the valid-once identifier 6 for the purpose of protecting the at least one digitized document 5. This makes it possible to provide secure encryption of the document or secure password protection of a memory location even when an easily remembered and hence relatively short valid-once identifier 6 is used.

In order to calculate the cryptographically secure key, it is possible to use a key derivation function. By way of example, this function may be a KDF1, a KDF2, a KDF3, a KDF4, an MGF1, a PBKDF-Schneider, a PBKDF1, a PBKDF2 and/or a scrypt key derivation function. In a further embodiment, a plurality of key derivation functions may be combined. Further key derivation functions are also possible. In this case, any function that may derive or calculate a cryptographically secure key from the valid-once identifier 6 may be regarded as a key derivation function.

In a further embodiment, the digitized document 5 is stored in a data memory 10, and the digitized document 5 is protected by password-protected access to the data memory 10 that is based on the valid-once identifier 6 and/or the calculated cryptographically secure key.

In a further embodiment, the digitized document 5 is protected against unauthorized access by being encrypted on the basis of the valid-once identifier 6 and/or the calculated cryptographically secure key. In this case, it is possible to use a multiplicity of different encryption algorithms. By way of example, encryption may be performed using symmetric and/or asymmetric encryption methods. Possible encryption methods include AES, DES, Triple-DES, IDEA, Blowfish, Twofish, RSA, and Merkle-Hellman. Further methods are also possible.

In one embodiment, the valid-once identifier 6 is stipulated at random. In this case, in one embodiment, the valid-once identifier 6 may be stipulated on the basis of a secrecy level that is prescribed for the at least one digitized document 5. In this case, the secrecy level for a digitized document 5 may be stipulated, by way of example, using descriptions such as “for internal use only,” “confidential,” and/or “strictly confidential”. The secrecy level may also be stipulated numerically, for example, however.

In this case, an all the more complex valid-once identifier 6 is produced the higher or more critical the secrecy level of a digitized document 5.

In one embodiment, the valid-once identifier 6 may also be requested from a user.

Finally, in one embodiment, the protected digitized document 5 may be sent to a prescribed receiver as an attachment to an electronic message, e.g., an e-mail.

In this case, the electronic message may be sent as an electronic message encrypted on the basis of a symmetric and/or an asymmetric encryption method, for example. It is possible to use PGP-compatible encryption, for example. In this case, the digitized document 5 may itself be encrypted and then transmitted in an encrypted electronic message, or the digitized document 5 may be attached to the electronic message in unencrypted form and encrypted together with the message. The aforementioned encryption methods may also be used in this case. Further encryption methods are likewise possible.

FIG. 3 depicts a block diagram of a further embodiment of an apparatus 1.

The apparatus 1 in FIG. 3 is likewise in the form of an MFD 1. In further embodiments, the apparatus 1 may also be in the form of a simple scanner 1 or the like, however.

The MFD 1 in FIG. 3 differs from the MFD 1 in FIG. 1 in that further components are provided besides the document scanning device 2 and the security device 4.

The security device 4 in FIG. 3 has a key derivation device 7 that may calculate a cryptographically secure key from a valid-once identifier 6 for the purpose of protecting a digitized document 5. In addition, a random number generator 8 is provided that provides the key derivation device 7 with a randomly produced valid-once identifier 6. In addition, a user interface 12 is provided that may request a valid-once identifier 6 from a user and for making available to the key derivation device 7. Finally, the security device 4 in FIG. 3 contains a computation unit 13 that protects the digitized document 5 on the basis of the cryptographically secure key calculated by the key derivation device 7.

In addition, the MFD 1 contains a data memory 10. In such an embodiment, the security device 4 may protect the digitized document 5 by virtue of the digitized document 5 being stored in the data memory 10 and the data memory 10 being provided with password-protected access.

In addition, the MFD 1 has a network interface 9 and a control device 11. By way of example, users may use the network interface 9 and the control device 11 to access the memory 10 of the MFD 1 via a data network.

In one embodiment, the control device 11 is designed to transmit the protected digitized document 5 to a prescribed receiver via the network interface 9 as an attachment to an electronic message. In this case, the electronic message and the attachments contained therein may be encrypted prior to sending on the basis of a symmetric and/or an asymmetric encryption method.

In one embodiment, an apparatus for digitizing documents is provided, where the apparatus is configured to digitize 51 at least one document 3 that is present in paper form. The apparatus is further configured to protect S2 the at least one digitized document 5 against unauthorized access on the basis of a valid-once identifier 6.

In one embodiment, an apparatus is configured to calculate a cryptographically secure key from the valid-once identifier 6 for the purpose of protecting the at least one digitized document 5.

In one embodiment, an apparatus is configured to store the at least one digitized document 5 in the data memory 10. The apparatus is further configured to protect the at least one digitized document 5 by password-protected access to the data memory 10 that is based on the valid-once identifier 6 and/or the calculated cryptographically secure key.

In one embodiment, an apparatus is configured to encrypt the at least one digitized document 5 on the basis of the valid-once identifier 6 and/or the calculated cryptographically secure key.

In one embodiment, an apparatus is configured to stipulate the valid-once identifier 6 at random, particularly on the basis of a secrecy level that is prescribed for the at least one digitized document 5, or request the valid-once identifier 6 from a user.

In one embodiment, an apparatus is configured to transmit the at least one protected digitized document 5 to a prescribed receiver as an attachment to an electronic message, particularly as an electronic message encrypted on the basis of a symmetric and/or an asymmetric encryption method.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An apparatus for digitizing documents, the apparatus comprising:
a document scanning device configured to digitize at least one document present in paper form; and
a security device configured to protect the at least one digitized document against unauthorized access on the basis of a valid-once identifier.

2. The apparatus as claimed in claim 1, wherein the security device comprises a key derivation device configured to calculate a cryptographically secure key from the valid-once identifier to protect the at least one digitized document.

3. The apparatus as claimed in claim 2, further comprising a data memory,
wherein the security device is configured to store the at least one digitized document in the data memory and protect the at least one digitized document by means of password-protected access to the data memory that is based on the valid-once identifier, the calculated cryptographically secure key, or the valid-once identifier and the calculated cryptographically secure key.

4. The apparatus as claimed in claim 2, wherein the security device is configured to encrypt the at least one digitized document on the basis of the valid-once identifier, the calculated cryptographically secure key, or the valid-once identifier and the calculated cryptographically secure key.

5. The apparatus as claimed in claim 1, wherein the security device comprises a random number generator configured to stipulate the valid-once identifier at random.

6. The apparatus as claimed in claim 5, wherein the random number generator is configured to stipulate the valid-once identifier at random on the basis of a secrecy level prescribed for the at least one digitized document.

7. The apparatus as claimed in claim 1, wherein the security device is configured to request the valid-once identifier from a user.

8. The apparatus as claimed in claim 1, further comprising a network interface and
a control device, wherein the control device is configured to transmit the at least one protected digitized document to a prescribed receiver via the network interface as an attachment to an electronic message.

9. The apparatus as claimed in claim 8, wherein the control device is configured to encrypt the electronic message and the attachments contained therein prior to sending on the basis of a symmetric encryption method, an asymmetric encryption method, or a symmetric encryption method and an asymmetric encryption method.

10. A method for digitizing documents, the method comprising:
digitizing at least one document present in paper form;
protecting the at least one digitized document against unauthorized access on the basis of a valid-once identifier.

11. The method as claimed in claim 10, further comprising:
calculating a cryptographically secure key from the valid-once identifier to protect the at least one digitized document.

12. The method as claimed in claim 11, further comprising:
storing the at least one digitized document in the data memory; and
protecting the at least one digitized document by password-protected access to the data memory that is based on the valid-once identifier, the calculated cryptographically secure key, or the valid-once identifier and the calculated cryptographically secure key.

13. The method as claimed in claim 11, further comprising:
encrypting the at least one digitized document on the basis of the valid-once identifier, the calculated cryptographically secure key, or the valid-once identifier and the calculated cryptographically secure key.

14. The method as claimed in claim 10, further comprising
stipulating the valid-once identifier at random, on the basis of a secrecy level that is prescribed for the at least one digitized document; or
requesting the valid-once identifier from a user.

15. The method as claimed in claim 10, further comprising:
transmitting the at least one protected digitized document to a prescribed receiver as an attachment to an electronic message, wherein the electronic message is encrypted on the basis of a symmetric encryption method, an asymmetric encryption method, or a symmetric encryption method and an asymmetric encryption method.

16. The method as claimed in claim 12, further comprising:
encrypting the at least one digitized document on the basis of the valid-once identifier, the calculated cryptographically secure key, or the valid-once identifier and the calculated cryptographically secure key.

17. The method as claimed in claim 16, further comprising
stipulating the valid-once identifier at random on the basis of a secrecy level that is prescribed for the at least one digitized document; or
requesting the valid-once identifier from a user.

18. The apparatus as claimed in claim 3, wherein the security device is configured to encrypt the at least one digitized document on the basis of the valid-once identifier, the calculated cryptographically secure key, or the valid-once identifier and the calculated cryptographically secure key.

19. The apparatus as claimed in claim 3, further comprising a network interface and a control device,
wherein the control device is configured to transmit the at least one protected digitized document to a prescribed receiver via the network interface as an attachment to an electronic message.

20. The apparatus as claimed in claim 19, wherein the control device is configured to encrypt the electronic message and the attachments contained therein prior to sending on the basis of a symmetric encryption method, an asymmetric encryption method, or a symmetric encryption method and an asymmetric encryption method.
